(19) United States
(12) Patent Application Publication
(10) Pub. No.: US 2004/0090776 A1
(43) Pub. Date: May 13, 2004

(54) Light device having flexible holder

(76) Inventor: Ah Mi Yang, Da Li City (TW)

Correspondence Address: CHARLES E BAXLEY, HART BAXLEY DANIELS & HOLTON, 90 JOHN STREET THIRD FLOOR, NEW YORK, NY, 10038, US

(21) Appl. No.: 10/289,564

(22) Filed: Nov. 8, 2002

(51) Int. Cl. F21L 4/00

(52) U.S. Cl. 362/189

(57) ABSTRACT

A light device includes a socket disposed on one end of a flexible holder for coupling to a light member which may generate a light to light the dark working areas. A magnetically attracting member may further be used for magnetically attracting elements. A barrel is attached to the flexible holder for receiving the light member, and for receiving the magnetically attracting member. A handle is attached to the flexible holder for receiving one or more batteries for energizing the light member. Another magnetic member may be attached to the handle for magnetically attracting elements.

### BACKGROUND OF THE INVENTION

1. Field of the Invention

The present invention relates to a light device, and more particularly to a light device having a flexible holder for engaging the light device into deep holes or portions or spaces or the like of such as the vehicles.

2. Description of the Prior Art

Typically, light devices are required to be provided for lighting the bottom portion or the engine rooms of the vehicles while fixing or repairing the vehicles. However, the light devices may not be engaged into the deep spaces in the engine rooms of the vehicles, such that the inner parts or elements may not be clearly lighted by the typical light devices.

U.S. Pat. No. 4,907,137 to Schiaditz et al. discloses the other typical light device having a flexible support of holder. However, the typical light device is required to be attached to an electric rail and may not be easily moved and engaged into the deep portions of the vehicles.

U.S. Pat. No. 5,276,596 to Krenzel discloses a further typical light device having a flexible support or holder. However, a flashlight is loosely held by a holder member, and is perpendicular to the flexible holder, such that the typical light device also may not be easily moved and engaged into the deep portions of the vehicles.

The present invention has arisen to mitigate and/or obviate the afore-described disadvantages of the conventional light devices.

### SUMMARY OF THE INVENTION

The primary objective of the present invention is to provide a light device including a flexible holder for engaging the light device into deep holes or portions or spaces or the like of the objects, such as the vehicles.

The other objective of the present invention is to provide a light device including a magnet member for attracting parts or members in the deep portions or spaces of the objects, such as the vehicles.

In accordance with one aspect of the invention, there is provided a light device comprising a flexible holder including a first end and a second end, a socket attached to the first end of the flexible holder, a light member coupled to the socket, for generating a light to light dark areas, and a magnetically attracting means for magnetically attracting elements.

The magnetically attracting means includes a barrel attached to the first end of the flexible holder, and having a passage formed therein for receiving said light member, and for exposing the light member, and a magnetic member attached to the barrel.

The barrel includes an inner peripheral swelling provided therein for defining an inner peripheral recess and for receiving the magnetic member.

The light member includes a peripheral bulge extended radially and outwardly therefrom, the barrel includes an inner peripheral shoulder formed therein and defined by the peripheral swelling for engaging with the peripheral bulge of the light member.

The magnetic member includes a ring shape having a bore formed therein for receiving the light member.

The flexible holder includes a coupler attached to the first end thereof, and having a depression formed therein for receiving the socket.

A handle is further provided and attached to the second end of the flexible holder, at least one battery is received in the handle, and a switch is disposed in the handle for switching the battery to couple to the light member.

Another magnetic member may further be provided and attached to the handle for magnetically attracting elements.

The handle includes a casing slidably attached thereto and secured to the switch for supporting the magnetic member, and means for biasing the casing away from the battery.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a light device in accordance with the present invention;

FIG. 2 is an enlarged partial perspective view of the light device;

FIG. 3 is a partial exploded view of the light device;

FIG. 4 is a partial cross sectional view taken along lines 4-4 of FIG. 2; and

FIG. 5 is a partial cross sectional view taken along lines 5-5 of FIG. 1.

### DETAILED DESCRIPTION OF THE PREFERRED EMBODIMENT

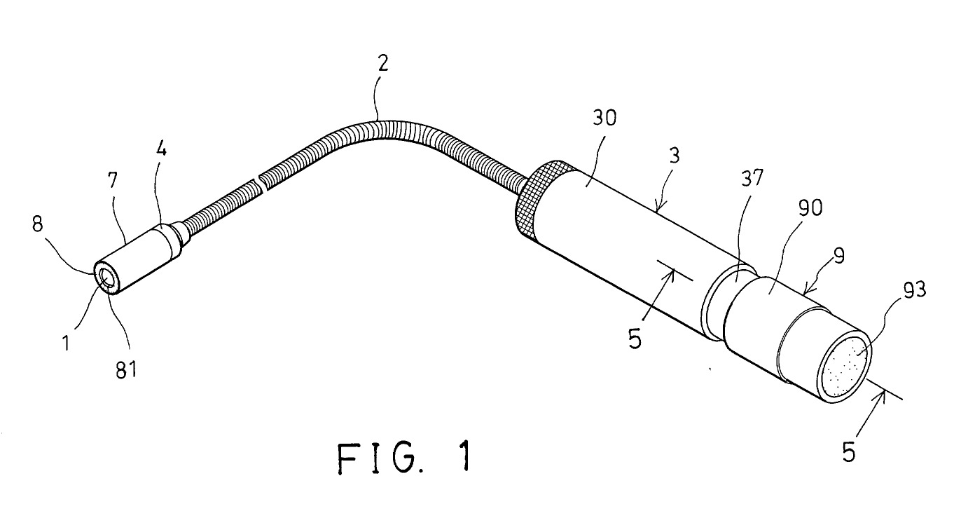

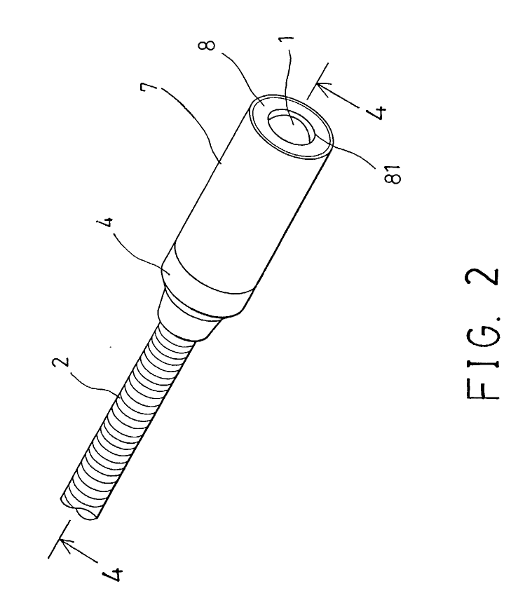

Referring to the drawings, and initially to FIGS. 1-4, a light device in accordance with the present invention comprises a light member 1 to be attached to one end of a flexible holder 2, particularly attached to the front end of a flexible and tubular holder 2.

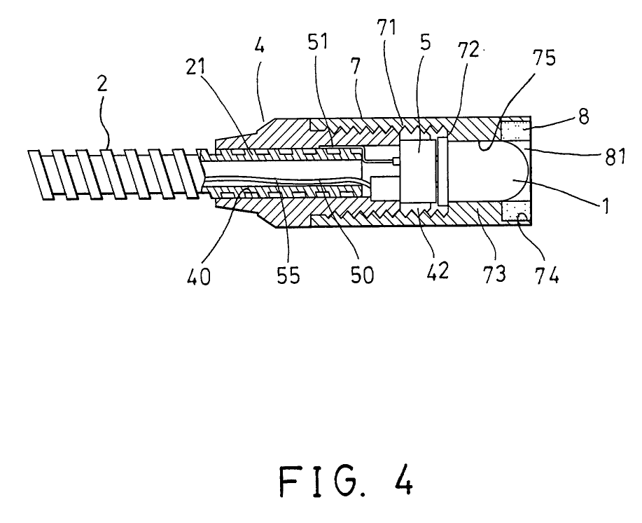

For example, a coupler 4 is engaged or attached onto one end 21 of the flexible holder 2, and includes a bore 40 (FIG. 4) formed therein for receiving the one end 21 of the flexible holder 2, a threaded end 41, and a depression 42 formed in the threaded end 41 and communicating with the bore 40 thereof.

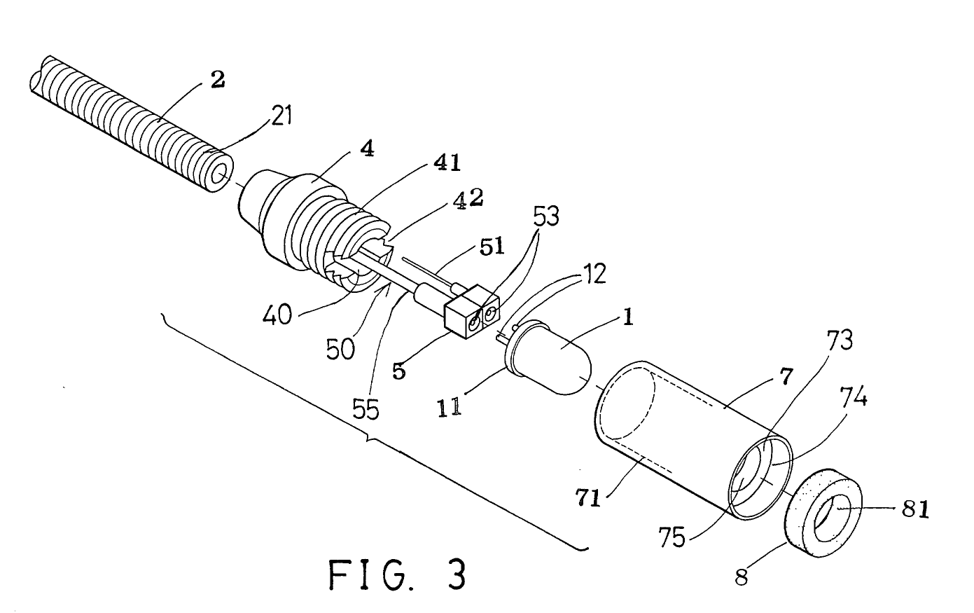

A socket 5 is engaged or received or supported in the depression 42 of the coupler 4, and includes one or more, such as two socket openings 53 formed therein for plugging or receiving the prongs 12 (FIG. 3) of the light member 1. The light member 1 includes a peripheral bulge 11 extended radially and outwardly therefrom.

The socket 5 includes an electric wire 50 engaged through the bore 40 of the coupler 40 and engaged through the flexible holder 2 (FIG. 4), and another electric wire 51 clamped between the one end 21 of the flexible holder 2 and the coupler 4, for electrically coupling to the flexible holder 2 that is electrically conductive.

A barrel 7 includes an inner thread 71 formed therein for threading with the threaded end 41 of the coupler 4 and for attaching or securing the barrel 7 to the coupler 4. The barrel 7 includes an inner peripheral swelling 73 provided therein and defining a passage 75 therein for receiving the light member 1, and for allowing the light member 1 to be partially exposed out through the passage 75 of the barrel 7.

The barrel 7 includes an inner peripheral shoulder 72 formed therein, such as formed in the inner portion thereof and defined by the inner peripheral swelling 73, for engaging with the peripheral bulge 11 of the light member 1, and for retaining the light member 1 between the coupler 4 and the barrel 7.

The barrel 7 further includes an inner peripheral recess 74 formed therein, such as formed in the outer end portion thereof and defined by the inner peripheral swelling 73. A ring-shaped magnetic member 8 is engaged in the inner peripheral recess 74 of the barrel 7 and includes a bore 81 formed therein for receiving the light member 1, and for allowing the light member 1 to be extended through or partially received within the bore 81 of the magnetic member 8.

The light emitted or generated by the light member 1 may be emitted through the passage 75 of the barrel 7 and the bore 81 of the magnetic member 8, for engaging into and for lighting the inner or deep portions or spaces or the like of the objects, such as the vehicles. In addition, the magnetic member 8 may further be provided for attracting and fetching the elements or the parts dropped in the inner or deep portions of the objects.

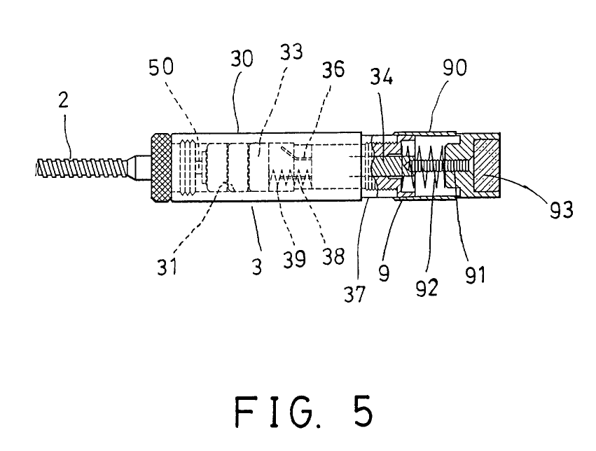

As shown in FIGS. 1, 5, a handle 3 is provided or attached to the other end, such as the rear end of the flexible holder 2, and includes a housing 30 secured to the flexible holder 2 and having a chamber 31 formed therein for receiving one or more batteries 33 therein that are provided for energizing the light member 1.

For example, the electric wire 50 from the socket 5 is coupled to such as the central electrode of the batteries 33, and is insulated or includes an insulated outer cover member 55 (FIGS. 3, 4) provided on the outer peripheral portion thereof for preventing the electric wire 50 from electrically contacting with the conductive flexible holder 2, and for allowing the electric wire 50 to be electrically coupled between the batteries 33 and the light member 1.

The handle 3 includes a switch 34 disposed in the rear portion of the housing 30 thereof. The switch 34 is electrically coupled between the case electrode of the batteries 33 and the conductive holder 2 with one or more conductors 36, 38, for switching or selectively coupling the case electrode of the batteries 33 to the light member 1 via the switch 34 and the flexible holder 2 and the electric wire 51 and the socket 5.

For example, the conductor 36 may be coupled to the conductive flexible holder 2, and the other conductor 38 may be selectively actuated to engage with or to be disengaged from the case electrode of the batteries 33, and may be biased away from the case electrode of the batteries 33 by such as a spring member 39.

An actuating device 9 may further be provided to actuate or to operate the switch 34, and includes a casing 90 slidably engaged onto the rear portion 37 of the housing 30 or of the handle 3. A fastener 91 may be engaged through the casing 90 and secured to the switch 34 for being moved in concert with the switch 34.

A spring member 92 may further be provided and engaged onto the fastener 91 or the switch 34, and biased between the casing 90 and the rear portion 37 of the housing 3, for biasing the switch 34 and the casing 90 away from the housing 3, and for disengaging the conductor 38 from the case electrode of the batteries 33 (FIG. 5).

In operation, as shown in FIG. 5, when the casing 90 is depressed toward the housing 3 against the spring 92, the switch 34 may be depressed and actuated to force or to electrically connect the conductor 38 with the case electrode of the batteries 33, in order to energize the light member 1 via the electric wires 50, 51 and the flexible holder 2.

When the light member 1 is energized by the batteries 33, the light member 1 may generate and emit the light emit through the passage 75 of the barrel 7 and the bore 81 of the magnetic member 8, in order to light the inner or deep portions or spaces or the like of the objects, such as the vehicles.

An additional magnetic member 93 may further be provided and attached to the casing 90, for attracting and fetching the elements or the parts dropped in the inner or deep portions of the objects. Either of both of the magnetic members 8, 93 may thus be selectively used for easily fetching the elements or the parts dropped in the inner or deep portions or dark areas of the objects.

Accordingly, the light device in accordance with the present invention includes a flexible holder for engaging the light device into deep holes or portions or spaces or the like of the objects, such as the vehicles, and may further include a magnet member for attracting parts or members in the deep portions or spaces or the dark areas of the objects, such as the vehicles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light device comprising:
a flexible holder including a first end and a second end,
a socket attached to said first end of said flexible holder,
a light member coupled to said socket, for generating a light to light dark areas, and
a magnetically attracting means for magnetically attracting elements.

2. The light device according to claim 1, wherein said magnetically attracting means includes a barrel attached to said first end of said flexible holder, and having a passage formed therein for receiving said light member, and for exposing said light member, and a magnetic member attached to said barrel.

3. The light device according to claim 2, wherein said barrel includes an inner peripheral swelling provided therein for defining an inner peripheral recess and for receiving said magnetic member.

4. The light device according to claim 3, wherein said light member includes a peripheral bulge extended radially and outwardly therefrom, said barrel includes an inner peripheral shoulder formed therein and defined by said peripheral swelling for engaging with said peripheral bulge of said light member.

5. The light device according to claim 2, wherein said magnetic member includes a ring shape having a bore formed therein for receiving said light member.

6. The light device according to claim 1, wherein said flexible holder includes a coupler attached to said first end thereof, and having a depression formed therein for receiving said socket.

7. The light device according to claim 1 further comprising a handle attached to said second end of said flexible holder, at least one battery received in said handle, and a switch disposed in said handle for switching said at least one battery to couple to said light member.

8. The light device according to claim 7 further comprising a magnetic member attached to said handle for magnetically attracting elements.

9. The light device according to claim 1, wherein said handle includes a casing slidably attached thereto and secured to said switch for supporting said magnetic member, and means for biasing said casing away from said at least one battery.
